(19) United States
(12) Patent Application Publication
(10) Pub. No.: US 2026/0343500 A1
(43) Pub. Date: Oct. 29, 2026

(54) METHODS AND DEVICES FOR CONFIGURING TIME DOMAIN RESOURCE FOR FULL DUPLEX

(71) Applicant: ZTE Corporation, Shenzhen (CN)

(72) Inventors: Xing LIU, Shenzhen (CN); Xingguang Wei, Shenzhen (CN); Xianghui Han, Shenzhen (CN); Jing Shi, Shenzhen (CN); Wei Gou, Shenzhen (CN)

(73) Assignee: ZTE Corporation, Shenzhen (CN)

(21) Appl. No.: 19/678,540

(22) Filed: May 15, 2026

Related U.S. Application Data
(63) Continuation of application No. PCT/CN2024/070230, filed on Jan. 2, 2024.

(51) Int. Cl. H04W 72/0446; H04L 5/14

(52) U.S. Cl. CPC H04W 72/0446; H04L 5/14

(57) ABSTRACT

The present disclosure describes methods, system, and devices for configuring time domain resources for full duplex (FD). One method includes receiving, by a user equipment (UE), configuration information from a base station for configuring FD resource in a time domain; and determining, by the UE, the FD resource in the time domain based on the configuration information. Another method includes determining, by a base station, FD resource in a time domain; and sending, by the base station, configuration information to a UE for configuring the FD resource in the time domain.

### TECHNICAL FIELD

The present disclosure is directed generally to wireless communications. Particularly, the present disclosure relates to methods and devices for configuring time domain resources for full duplex (FD).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some existing wireless communication schemes, an uplink (UL) symbol or slot may be configured/scheduled to transmit data or control information from a user equipment to a base station; and a downlink (DL) symbol or slot may be configured/scheduled to transmit data or control information from the base station to the UE. In some implementations, it may be worth allowing the simultaneous existence of downlink and uplink; however, many issues/problems may need to be solved to achieving such implementations. One of the issues/problems, for example, may include how to configure or define or use time domain structure for allowing the simultaneous existence of downlink and uplink.

The present disclosure describes various embodiments of configuring time domain resources for full duplex (FD), addressing at least one of the issues/problems discussed above, improving performance of the wireless communication, particularly the performance of uplink transmission of data/control information.

### SUMMARY

This document relates to methods, systems, and devices for wireless communication, and more specifically, for configuring time domain resources for full duplex (FD). The various embodiments in the present disclosure may be beneficial to enhance efficient utilization of spectrum resources, increase the telecommunication resource utilization efficiency, and/or boost performance of the wireless communication.

In one embodiment, the present disclosure describes a method for wireless communication. The method includes receiving, by a user equipment (UE), configuration information from a base station for configuring full duplex (FD) resource in a time domain; and determining, by the UE, the FD resource in the time domain based on the configuration information.

In another embodiment, the present disclosure describes another method for wireless communication. The method includes determining, by a base station, full duplex (FD) resource in a time domain; and sending, by the base station, configuration information to a user equipment (UE) for configuring the FD resource in the time domain.

In some other embodiments, an apparatus for wireless communication may include a memory storing instructions and a processing circuitry in communication with the memory. When the processing circuitry executes the instructions, the processing circuitry is configured to carry out any of the above methods.

In some other embodiments, a device for wireless communication may include a memory storing instructions and a processing circuitry in communication with the memory. When the processing circuitry executes the instructions, the processing circuitry is configured to carry out any of the above methods.

In some other embodiments, a computer-readable medium comprising instructions which, when executed by a computer, cause the computer to carry out any of the above methods. The computer-readable medium may be a non-transitory computer-readable medium.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows one exemplary configuration pattern of an uplink (UL) subband in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a schematic diagram of an exemplary embodiment for wireless communication.

FIG. 5B shows a schematic diagram of an exemplary embodiment for wireless communication.

FIG. 5C shows a schematic diagram of an exemplary embodiment for wireless communication.

FIG. 6A shows a schematic diagram of another exemplary embodiment for wireless communication.

FIG. 6B shows a schematic diagram of another exemplary embodiment for wireless communication.

FIG. 6C shows a schematic diagram of another exemplary embodiment for wireless communication.

FIG. 6D shows a schematic diagram of another exemplary embodiment for wireless communication.

FIG. 6E shows a schematic diagram of another exemplary embodiment for wireless communication.

FIG. 7 shows a schematic diagram of another exemplary embodiment for wireless communication.

FIG. 8A shows a schematic diagram of another exemplary embodiment for wireless communication.

FIG. 8B shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring time domain resources for full duplex (FD).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

The 4th Generation mobile communication technology (4G) Long-Term Evolution (LTE) or LTE-Advance (LTE-A), the 5th Generation mobile communication technology (5G), and the further 6th Generation mobile communication technology (6G) face more and more demands. Based on the current development trend, 4G and 5G systems are developing supports on features of enhanced mobile broadband (eMBB), ultra-reliable low-latency communication (URLLC), and massive machine-type communication (mMTC).

In some existing wireless communication schemes, an uplink (UL) symbol or slot may be configured/scheduled to transmit data or control information from a user equipment to a base station; and a downlink (DL) symbol or slot may be configured/scheduled to transmit data or control information from the base station to the UE. In some implementations, it may be worth allowing the simultaneous existence of downlink and uplink; however, many issues/problems may need to be solved to achieving such implementations. One of the issues/problems, for example, may include how to configure or define or use time domain structure for allowing the simultaneous existence of downlink and uplink.

In a wireless communication system, time domain resource may be split between downlink and uplink in time division duplex (TDD). Allocation of a limited time duration for the uplink in TDD would result in reduced coverage, increased latency and reduced capacity. In some implementations, to provide possible enhancement on this limitation of the conventional TDD operation, simultaneous existence of downlink and uplink may be allowed, a.k.a. full duplex (FD), or more specifically, subband non-overlapping full duplex (SBFD) at a base station (e.g., gNB) within a conventional TDD band. In some implementations, for some symbols configured as semi-static downlink resource or flexible resource, a part of frequency resource may be configured as UL resource, e.g., UL subband. The downlink or flexible symbols configured with UL subband may be called as SBFD resource or SBFD symbols. In some implementations, for some symbols configured as semi-static uplink resource or flexible resource, a part of frequency resource may be configured as DL resource, e.g., DL subband. The uplink or flexible symbols configured with DL subband may be called as SBFD symbols. Therefore, in various implementations, both of uplink and downlink may exist in different frequency domain resource of a same time domain resource.

The present disclosure describes methods and devices for configuring and/or defining and/or using time domain resources for full duplex (FD) or SBFD system. In the present disclosure, SBFD may be referred in various steps, methods, implementations, embodiments, or examples, which are applicable to FD as well. In the present disclosure, slot(s) (or slot-level) may be described in various steps, methods, implementations, embodiments, or examples; and/or symbol(s) (or symbol-level) may be described in various other steps, methods, implementations, embodiments, or examples, which is not a limitation. A portion or all of the described embodiments or implementations may be applicable to both the level of slots and the level of symbols.

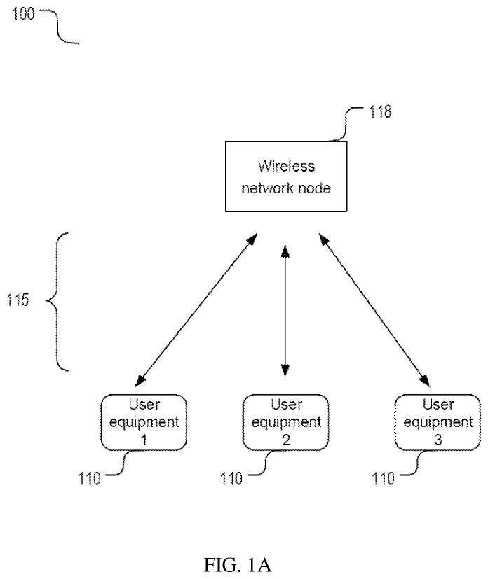

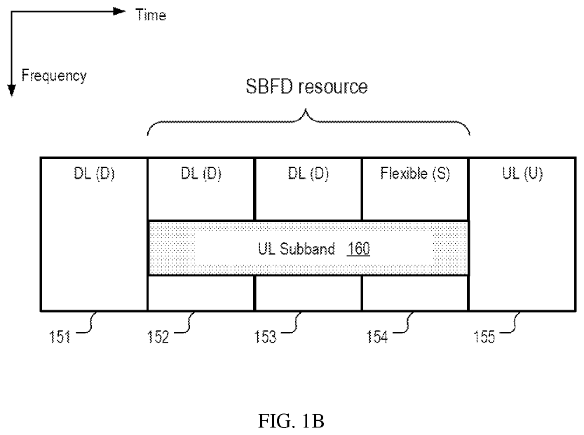

FIG. 1A shows a wireless communication system 100 including a wireless network node 118 and one or more user equipment (UE) 110. The wireless network node may include a network base station, which may be a nodeB (NB, gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

In some implementations, in an SBFD or FD system, some time domain resource (e.g., a group of symbols, slots, subframe, etc.) may be configured as one of the following structures in the frequency domain, ‘DUD’, ‘DU’, ‘UD’, wherein, D represents downlink resource, U represents uplink resource; and there are both downlink resource and uplink resource in the same time domain resource. In some implementations, these types of time domain resource may be called as SBFD resource or SBFD symbols (or slots). More specifically, UL resource (including a group of consecutive uplink resource blocks (RBs)) is introduced into a DL or flexible(S) symbol configured via a higher layer signaling, e.g., frame structure configuration signaling. In some implementations, the UL resource may also be called as UL subband, and the remaining DL resource in the SBFD resource may be called as DL subband. Similarly, in some other examples, a DL subband (including a group of consecutive downlink RBs) is introduced into a UL or flexible symbol configured via a higher layer signaling. An SBFD resource with ‘UDU’, ‘DU’ or ‘UD’ structure in the frequency domain may be obtained. For example, the SBFD resource is obtained by inserting UL resource into DL or flexible symbol. In some implementations, the described methods may also applied to some other examples including the SBFD resource being obtained by inserting DL resource into UL or flexible symbol.

For a non-limiting example, referring to FIG. 1B, a typical symbol/slot structure is DDDSU (151, 152, 153, 154, and 155). Here, D represents a DL symbol/slot, U represents a UL symbol/slot, and S represents a flexible symbol/slot, which contains DL symbols and UL symbols. Obviously, UL slots are fewer, which may affect the performance of UL transmission. For example, due to no more consecutive or available UL slots, a large data volume of UL may not be supported, and/or more importantly, a timeliness and edge coverage of UL transmission may be relatively poor. In some implementations, a full-duplex technology based on the UL subband may be implemented as subband full duplex (SBFD), wherein the configuration patterns of the UL subband may have the various types. FIG. 1B shows one type of the configuration pattern of the UL subband, wherein a UL subband 160 is configured in DL symbols/slots and flexible symbols/slots. In some implementations, the UL subbands may be configured only in DL symbols/slots. In some implementations, the UL subbands may be configured in some or all DL symbols/slots. In some implementations, the UL subbands may be configured in some or all of the DL symbols/slots and some or all of the flexible symbols/slots. In some implementations, the UL subbands may be in DL symbols/slots, flexible symbols/slots and UL symbols/slots. In some implementations, the UL subbands may be configured in some or all of the DL symbols/slots, some or all of the flexible symbols/slots, and some or all of the UL symbols/slots.

In various embodiments, a UL subband may provide continuous UL symbols/slots, which is beneficial to expand UL resources, to reduce the delay of UL transmission, for example, by reducing the time waiting for UL opportunities, and/or to improve uplink coverage. The present disclosure describes various embodiments for configuring time domain resources for FD or SBFD.

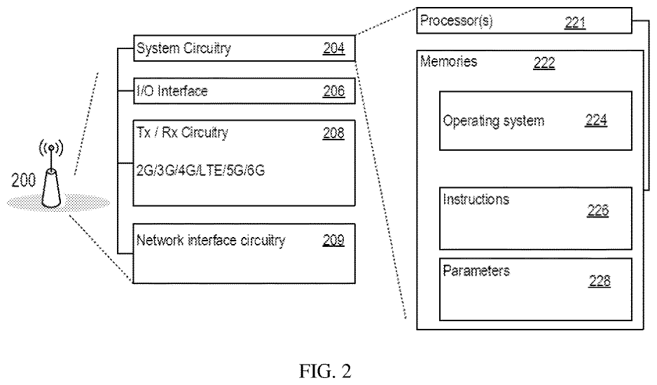

FIG. 2 shows an example of electronic device 200 to implement a network base station (or a wireless communication node). The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

FIG. 3 shows an example of an electronic device to implement a terminal device 300 (for example, user equipment (UE), or wireless communication device). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 may send, or has received, through the communication interfaces 302. In various implementations, a system power for the UE 300 may be supplied by a power storage device, such as a battery or a transformer.

The present disclosure describes various embodiment for configuring time domain resources for FD and/or SBFD, which may be implemented, partly or totally, by the network base station and/or the user equipment described above in FIGS. 2-3. The various embodiments in the present disclosure may enable efficient utilization of spectrum resources in the telecommunication system, which may increase the overall communication efficiency and/or boost latency performance of communication traffic.

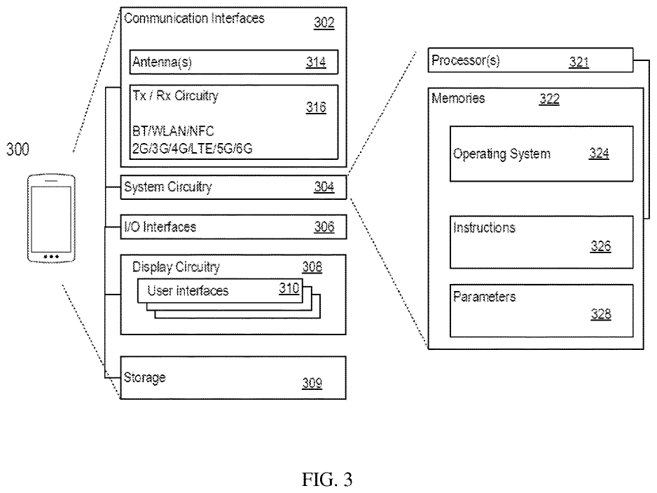

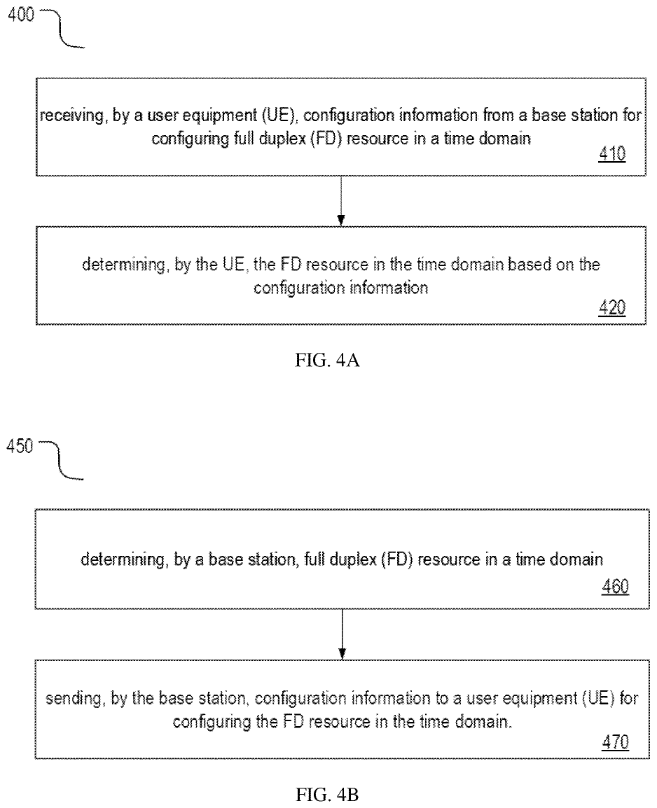

Referring to FIG. 4A, the present disclosure describes various embodiments of a method 400 for wireless communication. The method 400 may be performed by a wireless communication device (e.g., a user equipment). The method 400 may include a portion or all of the following; step 410, receiving, by a user equipment (UE), configuration information from a base station for configuring full duplex (FD) resource in a time domain; and/or step 420, determining, by the UE, the FD resource in the time domain based on the configuration information.

Referring to FIG. 4B, the present disclosure describes various embodiments of a method 450 for wireless communication. The method 450 may be performed by a wireless communication node (e.g., a base station or a radio access network (RAN)). The method 450 may include a portion or all of the following: step 460, determining, by a base station, full duplex (FD) resource in a time domain; and/or step 470, sending, by the base station, configuration information to a user equipment (UE) for configuring the FD resource in the time domain.

In some implementations, a starting position of the FD resource in the time domain is determined based on at least one of the following comprised in the configuration information: a slot index within a frame structure period, a symbol index within a slot or a frame structure period, or a time domain offset from a reference point; and/or an ending position of the FD resource in the time domain is determined as one of the following: a starting position of a first uplink (UL) or flexible slot within the frame structure period, a first uplink (UL) or flexible symbol within the frame structure period, or an ending position of a last downlink (DL) slot or symbol within the frame structure period.

In some implementations, an ending position of the FD resource in the time domain is determined based on at least one of the following comprised in the configuration information: a slot index within a frame structure period, a symbol index within a slot or a frame structure period, or a time domain offset from a reference point; and/or a starting position of the FD resource in the time domain is determined as one of the following: a starting position of a first DL slot or symbol within the frame structure period, or a starting position of the frame structure period.

In some implementations, a first position within a frame structure period in the time domain is determined based on at least one of the following comprised in the configuration information: a slot index within the frame structure period, a symbol index within a slot or the frame structure period, or a time domain offset from a reference point; and/or a second position within the frame structure period in the time domain is determined based on an indicator comprised in the configuration information; and/or the FD resource in the time domain is determined as a time duration between the first position and the second position within the frame structure period, wherein the FD resource in the time domain is determined as a time duration from the first position to the second position within the frame structure period or as a time duration from the second position to the first position within the frame structure period.

In some implementations, the indicator comprises one bit; and/or the indicator being a first value indicates the second position within the frame structure period as one of, a starting point of a first flexible or UL slot within the frame structure period, a starting point of a first flexible or UL symbol within the frame structure period, or an ending point of a last DL slot or symbol within the frame structure period; and/or the indicator being a second value indicates the second position within the frame structure period as a starting point of a first DL slot or symbol within the frame structure period or a starting point of the frame structure period.

In some implementations, a duration of the FD resource in the time domain is determined based on a number of slots or symbols comprised in the configuration information; and/or a position of the FD resource in the time domain is determined as being ended or started at a reference point.

In some implementations, the reference point is a pre-defined point in the frame structure period; or the reference point is comprised in the configuration information.

In some implementations, the FD resource comprises a first FD resource and a second FD resource; and/or the frame structure period comprises a first frame structure period and a second frame structure period; and/or the first FD resource and the second FD resource are independently configured in the first frame structure period and the second frame structure period, respectively.

In some implementations, a period for the first FD resource is same as a period of the second FD resource, and equals to a sum of the first frame structure period and the second frame structure period.

In some implementations, the frame structure period comprises a first frame structure period and a second frame structure period; and/or the FD resource is determined based on at least one of the following: a slot-level bitmap within the frame structure period, a symbol-level bitmap within one or more slot or the frame structure period, a starting symbol index of a starting slot indicated by the slot-level bitmap, or an ending symbol index of an ending slot indicated by the slot-level bitmap.

In some implementations, the slot-level bitmap corresponds to one of the following: all slots within the frame structure period, all DL slots within the frame structure period, or all DL and flexible slots within the frame structure period; and/or the symbol-level bitmap corresponds to one of the following: all symbols within the frame structure period, all DL symbols within the frame structure period, all DL and flexible symbols within the frame structure period, all symbols within a starting slot indicated by the slot-level bitmap, all DL symbols within the starting slot indicated by the slot-level bitmap, all DL symbols and flexible symbols within the starting slot indicated by the slot-level bitmap, all symbols within an ending slot indicated by the slot-level bitmap, all DL symbols within the ending slot indicated by the slot-level bitmap, all DL symbols and flexible symbols within the ending slot indicated by the slot-level bitmap, all symbols within the starting slot and the ending slot indicated by the slot-level bitmap, all DL symbols within the starting slot and the ending slot indicated by the slot-level bitmap, or all DL symbols and flexible symbols within the starting slot and the ending slot indicated by the slot-level bitmap.

In some implementations, the frame structure period comprises a first frame structure period and a second frame structure period; and/or the FD resource for the first frame structure period and the second frame structure period comprises a common FD resource; and/or the common FD resource is configured on an intersection of DL resources of the first frame structure period and the second frame structure period.

In some implementations, the frame structure period comprises a first frame structure period and a second frame structure period; and/or the FD resource for the first frame structure period and the second frame structure period comprises a common length; and/or starting points or ending points of the FD resource are determined separately for the first frame structure period and the second frame structure period.

In some implementations, the starting points or ending points of the FD resource for the first frame structure period and the second frame structure period comprise one of the following: a starting point of a first DL slot or symbol within each frame structure period, a starting point of each frame structure period, a starting point of a first UL or flexible slot or symbol within each frame structure period, or an ending point of a last DL slot or symbol within each frame structure period.

In some implementations, the frame structure period comprises a first frame structure period and a second frame structure period; and/or the FD resource for the first frame structure period and the second frame structure period comprises a common FD resource; and a period of the common FD resource equals to either of the first frame structure period or the second frame structure period; and/or in response to one or more slot or symbol of the common FD resource overlapping with UL or flexible resource, the one or more slot or symbol is invalid FD resource; and/or in response to one or more slot or symbol of the common FD resource overlapping with UL or flexible resource, the common FD resource in corresponding frame structure period is dropped.

In some implementations, the frame structure period comprises a first frame structure period and a second frame structure period; and/or the FD resource is configured for the first frame structure period and the second frame structure period; and/or a period of the FD resource equals to a sum of the first frame structure period and the second frame structure period; and/or in response to one or more slot or symbol of the FD resource overlapping with UL or flexible resource, the one or more slot or symbol is invalid FD resource.

In some implementations, the FD resource is configured in flexible resource configured by cell-specific time division duplex (TDD) frame structure configuration; and/or all of the FD resource configured in the flexible resource is configured as DL resource by UE-specific TDD frame structure configuration, all of the FD resource configured in the flexible resource is configured as DL resource or flexible resource by the UE-specific TDD frame structure configuration, none of the FD resource configured in the flexible resource is configured as UL resource by the UE-specific TDD frame structure configuration, the FD resource configured in the flexible resource is terminated by UL resource configured by the UE-specific TDD frame structure configuration, the FD resource configured in the flexible resource is terminated by flexible resource configured by UE-specific TDD frame structure configuration, or the FD resource configured in the flexible resource is divided into multiple segments by UL resource configured by the UE-specific TDD frame structure configuration.

In some implementations, the FD resource is configured as a two-level configuration comprising a first level FD configuration and a second level FD configuration; and/or the first level FD configuration is configured within DL resource configured by cell-specific TDD frame structure configuration; and/or the second level FD resource is configured within the DL resource or within either the DL resource or flexible resource configured by UE-specific TDD frame structure configuration; and/or the first level FD resource and the second level FD resource are continuous in the time domain.

The present disclosure describes various non-limiting embodiments as below, which is merely to illustrate the application, and does not impose limitations. In some embodiments, SBFD is used as non-limiting example, and the disclosed embodiments are generally applicable to FD as well.

### Embodiment Set I

The present disclosure describes various embodiments including methods for configuring or defining time domain structure for the SBFD resource under a single period TDD frame structure.

In some implementations for a new radio (NR) system, a cell-common TDD frame structure may be configured by at least one of the following high layer parameters: a subcarrier spacing, a periodicity, a number of consecutive full DL slots at the beginning of each DL-UL pattern, a number of consecutive DL symbols in the beginning of the slot following the last full DL slot, a number of consecutive full UL slots at the end of each DL-UL pattern, a number of consecutive UL symbols in the end of the slot preceding the first full UL slot. In some implementations, all remaining symbols and slots may be defined as flexible resource.

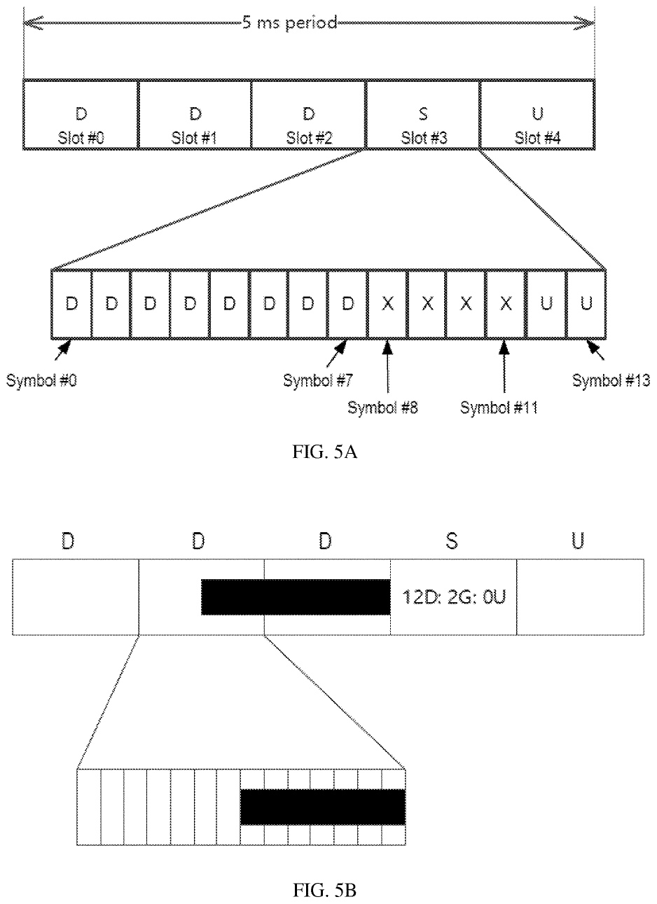

For a non-limiting example as shown in FIG. 5A, the periodicity is 5 millisecond (ms) and a subcarrier spacing is 15 kHz, so that the number of slots within a period is 5 (from slot #0 to slot #4) and there are 14 symbols in each slot (from symbol #0 to symbol #13). The number of consecutive full DL slots at the beginning of each DL-UL pattern is 3. The number of consecutive DL symbols in the beginning of the slot following the last full DL slot is 8. The number of consecutive full UL slots at the end of each DL-UL pattern is 1. The number of consecutive UL symbols in the end of the slot preceding the first full UL slot is 2. There are four flexible symbols in the fourth slot, i.e., symbol #8~#11.

In some implementations, the time domain period of the SBFD resource may equal to the period of the TDD frame structure. Alternatively, the time domain period of the SBFD resource may be several times (e.g., an integer times) of the TDD frame structure period, for example, when the TDD frame structure period is 5 ms, the time domain period of the SBFD resource is twice (10 ms), three times (15 ms), etc.

In some implementations, the SBFD resource is continuous in the time domain. According to the cell-common frame structure configuration, the time domain resource of SBFD resource can be configured via at least one of the following methods.

For one method (Method 1-1): the time domain resource of SBFD resource may be configured via at least one of the following parameters: a starting slot index (or an offset from the beginning of a frame structure period), a starting symbol index within a slot (or a number of symbols from the starting of the starting slot), an ending slot index (or a number of slots occupied by the SBFD resource, or an offset from the beginning of flexible/UL slot) plus an ending symbol index within a slot (or a number of symbols from the starting of the ending slot).

For another method (Method 1-2): the time domain resource of SBFD resource may be configured via at least one of the following parameters: a slot level bitmap, or a symbol index within the starting slot and symbol index within the ending slot.

For another method (Method 1-3): the time domain resource of SBFD resource may be configured via at least one of the following parameters: a slot level bitmap, or a symbol level bitmap within the starting slot and a symbol level bitmap within the ending slot.

For another method (Method 1-4): the time domain resource of SBFD resource may be configured via at least one of the following parameters: a symbol index of the starting symbol within the frame structure period, and/or a symbol index of the ending symbol within the frame structure period.

For another method (Method 1-5): the time domain resource of SBFD resource may be configured via the following parameter: a symbol level bitmap within a frame structure period.

For another method (Method 1-6): starting time domain position of the SBFD resource may be configured via at least one of the following parameters: a slot index within a frame structure period, a symbol index within a slot or a frame structure period, a time domain offset from a reference point, wherein the time domain offset may be expressed in units of slot or symbol. The reference point may be defined as one of, the beginning of frame structure period, the end of the frame structure period, the beginning of first flexible/UL/DL slot or symbol and the end of the last flexible/UL/DL slot or symbol. The ending time domain position of the SBFD resource can be defined as, e.g., a starting of the first UL/flexible slot or symbol within the frame structure period or ending of the last DL slot or symbol within the frame structure period.

For a non-limiting example as shown in FIG. 5B, the frame structure period is 5 ms, for 15 kHz, there will be 5 slots (i.e., slot #0~slot #4) within a frame structure period in total. The frame structure is configured as DDDSU, in the S slot, the D/U Attribute in the symbol level is configured as 12D: 2G: 0U, wherein D represents downlink symbol, G represents gap symbol and U represents uplink symbol. The starting time domain position of the SBFD resource may be configured via a slot index (i.e., slot #1) within a frame structure period, a symbol index (i.e., symbol #7) within a slot. The ending time domain position of the SBFD resource may be defined as the ending of the last DL slot within the frame structure period, i.e., the ending point of slot #2. Therefore, the SBFD resource may be determined.

For another method (Method 1-7): an ending time domain position of the SBFD resource may be configured via at least one of the following parameters: a slot index within a frame structure period, a symbol index within a slot or a frame structure period, a time domain offset from a reference point, wherein the time domain offset may be expressed in units of slot or symbol. The reference point may be defined as one of, the beginning of frame structure period, the end of the frame structure period, the beginning of first flexible/UL/DL slot or symbol and the end of the last flexible/UL/DL slot or symbol. The starting time domain position of the SBFD resource may be defined as, e.g., a starting of the first DL slot or symbol within the frame structure period or a starting of the frame structure period.

For another method (Method 1-8): a first time domain position within a frame structure period may be configured via at least one of the following parameters: a slot index, a symbol index within a slot or a frame structure period, a time domain offset from a reference point, wherein the time domain offset may be expressed in units of slot or symbol. The reference point can be defined as one of, the beginning of frame structure period, the end of the frame structure period, the beginning of first flexible/UL/DL slot or symbol and the end of the last flexible/UL/DL slot or symbol. An indication is used for indicating a second time domain position. For example, the indication has a single bit, and can be used for indicating one of two candidate time domain positions as the second time domain position; and the two candidate time domain positions can be, 1) starting of the first (earliest) flexible/UL slot or symbol within the frame structure period or ending of the last DL slot or symbol within the frame structure period; 2) the starting of the first (earliest) DL slot or symbol within the frame structure period or starting of the frame structure period. Here, the “first” slot or symbol may refer to the “earliest” slot or symbol, rather than referring to “a” slot or symbol. The time domain resource of SBFD resource can be defined as the time duration between the first time domain position and the second time domain position. Alternatively, the time domain resource of SBFD resource can be defined as the time duration between the second time domain position and the first time domain position.

For another method (Method 1-9): a number of slots or symbols of SBFD resource may be configured. And the time domain resource SBFD resource is ended or started at a reference point. The reference point can be defined as one of, the beginning of the frame structure period, the end of the frame structure period, the beginning of first flexible/UL/DL slot or symbol and starting of the first DL slot or symbol within the frame structure period.

In some embodiments, as the SBFD resource may be configured only in the DL resource or the flexible resource, in the foregoing method, all configurations within the frame structure period can also be indicated within a range of the DL resource set, or within a range of the DL resource set and the flexible resource set. The signaling overhead can be reduced. For example, a frame structure period of 5 ms includes five 15 kHz slots, and is configured as a DDDSU structure. For configuring slots on which the SBFD resource is located in a form of bitmap within the frame structure period, signaling overhead of the 5 bits is required, while the configuration scope is defined within a set of only DL resources, the bitmap of only 3 bits is required.

In some implementations, the SBFD resource configuration period may be a multiple of the frame structure period, for example, two times; and further, in each frame structure period, SBFD resource configuration is independently. There may be two different patterns of SBFD resource in different frame structure periods. For a non-limiting example as shown in FIG. 5C, the frame structure period is 5 ms; and the SBFD resource configuration period is two times of the frame structure period, i.e., 10 ms. Then, there are two independent SBFD resource configurations for the first frame structure period and the second frame structure period within the SBFD resource configuration period, respectively. More specifically, the SBFD resource in the first frame structure period is configured as slot #1 and slot #2. The SBFD resource in the second frame structure period is configured as slot #2. In this way, the SBFD resource can be configured more flexibly and efficiently.

Various embodiments in the present disclosure provide methods for configuring or defining time domain structure for the SBFD resource under single period TDD frame structure, through which the SBFD resource may be determined and indicated efficiently.

### Embodiment Set II

The present disclosure describes various embodiments including methods for configuring or defining time domain structure for the SBFD resource under two-pattern TDD frame structures.

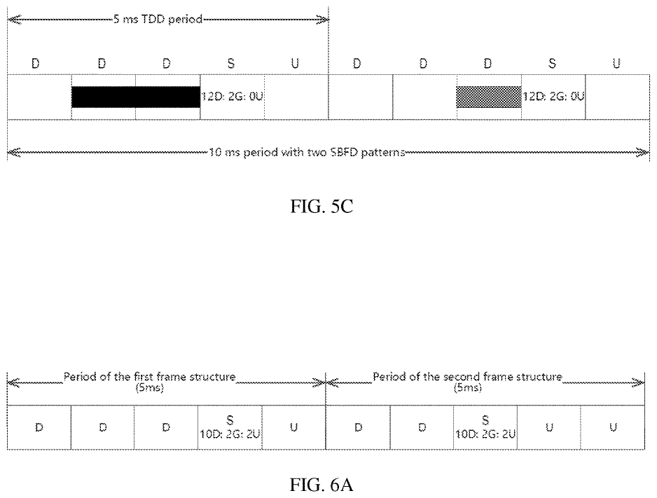

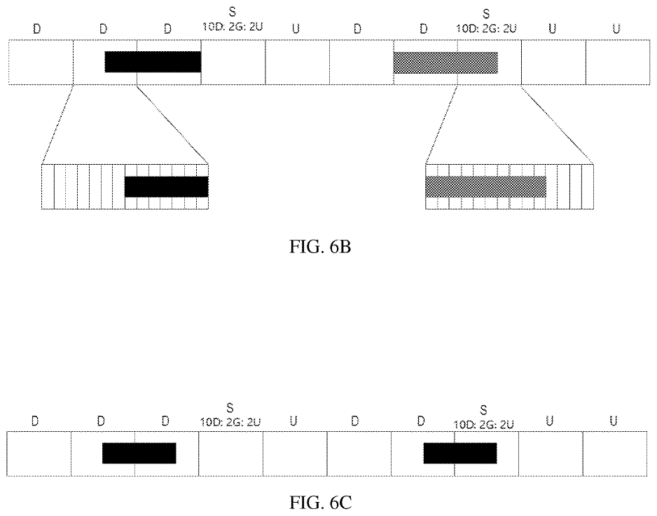

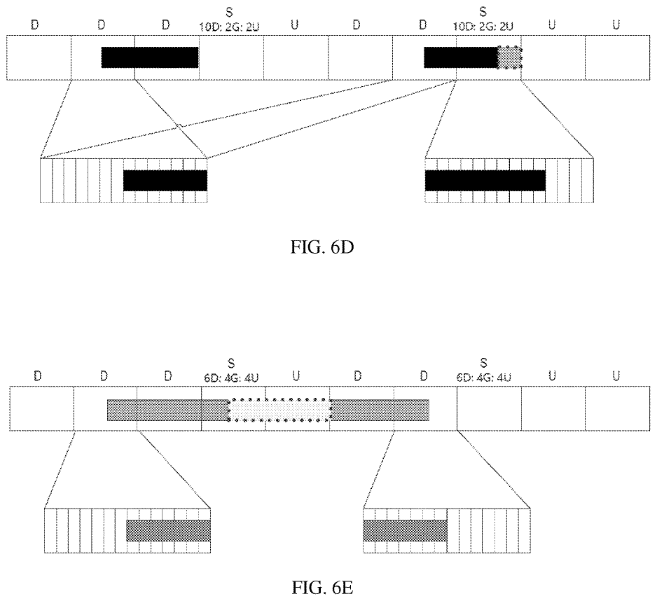

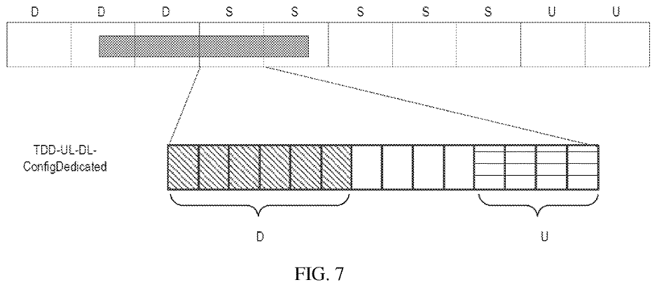

For a TDD carrier, two different frame structures (i.e., frame structure pattern) can be configured simultaneously, which can be called as two-pattern TDD frame structure. A non-limiting example is shown in FIG. 6A, wherein a first frame structure pattern can be configured with a first pattern period=5 ms and DDDSU, and a second frame structure can be configured with a second pattern period=5 ms and DDSUU. Then, the frame structure period can be considered as a sum of the first pattern period and the second pattern period, i.e., 10 ms. Then, the first frame structure and the second frame structure may appear alternately every 10 ms.

In various embodiments, for a two-period TDD frame structure configuration, the SBFD resource may be determined by one of the following methods.

For one method (Method 2-1): two independent SBFD resource configurations may be configured for two-pattern frame structures, respectively; and any method described in Embodiment Set may be used for the SBFD resource configuration. For example, in FIG. 6A, the first SBFD resource configuration is valid for the first frame structure, and the second SBFD resource configuration is valid for the second frame structure.

In some implementations, the configuration period for both of the first SBFD resource and the second SBFD resource is same, and equal to a sum of the first pattern period and the second pattern period.

For one non-limiting example, as shown in FIG. 6B, for the first SBFD resource, the starting slot index within the first frame structure period is slot #1 and the index of the starting symbol within the starting slot is symbol #7. The ending slot index within the first frame structure period is slot #2 and the index the ending symbol within the ending slot is symbol #13. For the second SBFD resource, the starting slot index within the second frame structure period is slot #1 and the index of the starting symbol within the starting slot is symbol #0. The ending slot index within the second frame structure period is slot #2 and the index the ending symbol within the ending slot is symbol #9.

For another non-limiting example, as shown in FIG. 6B, for the first SBFD resource, the starting slot index within the SBFD resource configuration period is slot #1 and the index of the starting symbol within the starting slot is symbol #7. The ending slot index within the SBFD resource configuration period is slot #2 and the index the ending symbol within the ending slot is symbol #13. For the second SBFD resource, the starting slot index within the SBFD resource configuration period is slot #6 and the index of the starting symbol within the starting slot is symbol #0. The ending slot index within the SBFD resource configuration period is slot #7 and the index the ending symbol within the ending slot is symbol #9.

For another method (Method 2-2): the SBFD resource is configured via at least one of, a slot-level within the frame structure period, i.e., a sum of the first pattern period and the second pattern period, a symbol-level bitmap within one or more slot or within the frame structure period, a starting symbol index of a starting slot indicated by the slot-level bitmap, or an ending symbol index of an ending slot indicated by the slot-level bitmap.

Under the example frame structure configuration shown in FIG. 6A, there are 10 slots within the frame structure period, and 10 bits slot-level bitmap may be used for configuring the SBFD resource. For example, the bitmap is set to ‘01100 01000’, then it represents that slot #1, slot #2, and slot #6 are configured as the SBFD resource.

In some implementations, a symbol-level bitmap is used for further indicating which symbols of the indicated slots are configured as FD resource. For example, the symbol-level bitmap (e.g., 14 bits) corresponds to all symbols within the starting slot indicated by the slot-level bitmap: the FD resource is started from the beginning of symbol #7 by setting the symbol level bitmap to ‘0000000 1111111’. As another example, the symbol-level bitmap (e.g., 14 bits) corresponds to all symbols within the ending slot indicated by the slot-level bitmap: the FD resource is ended at the end of symbol #6 by setting the symbol level bitmap to ‘1111111 0000000’.

In some implementations, a starting symbol index (e.g., 4 bits) is used for indicating the starting symbol of the FD resource of a starting slot indicated by the slot-level bitmap. For example, the FD resource is started from the beginning of symbol #7 by setting the starting symbol index to ‘0111’, which is a binary number having a real value of ‘7’ indicating the symbol #7.

In some implementations, an ending symbol index (e.g., 4 bits) is used for indicating the ending symbol of the FD resource of an ending slot indicated by the slot-level bitmap. For example, the FD resource is ended at the end of symbol #6 by setting the ending symbol index to ‘0110’, which is a binary number having a real value of ‘6’ indicating the symbol #6.

In some implementations, the SBFD resource is configured via at least one of, a slot-level within all of the DL resource of a frame structure period or within all of the DL and flexible resource of a frame structure period, a symbol-level bitmap within all of the DL resource of the frame structure period or within all of the DL and flexible resource of the frame structure period, or a symbol-level bitmap within all of the DL resource of one or more slot or within all of the DL and flexible resource of one or more slot. Under the frame structure configuration as shown in FIG. 6A, there are five DL slots within the frame structure period; and 5 bits slot-level bitmap may be used for configuring the SBFD resource. For example, the bitmap is set to ‘01101’, which represents that the second DL slot (i.e., slot #1), the third DL slot (i.e., slot #2), and the fifth DL slot (i.e., slot #6) are configured as the SBFD resource.

For another method (Method 2-3): a common SBFD resource configuration is used for both of the first frame structure and the second frame structure. The UE does not expect the configured SBFD resource is located in an UL resource. In other words, the SBFD resource is configured in the intersection of the DL resources of the two pattern periods. The SBFD resource can be configured by using any method described in Embodiment Set I.

For a non-limiting example as shown in FIG. 6C, the SBFD resource period equals to at least one of the pattern period, i.e., 5 ms in this example. The index of the starting slot within the SBFD resource period is slot #1, and the starting symbol index within the starting slot is symbol #7. The index of the ending slot within the SBFD resource period is slot #2, and the ending symbol index within the ending slot is symbol #9. Then, the same SBFD resource can be determined in either frame structure pattern.

In some implementations, the first pattern period and the second pattern period may be different. Then, the SBFD resource period may equal to any one of the first pattern period and the second pattern period, for example, specifically selecting a longer period among the two periods or specifically selecting a shorter period among the two periods.

For another method (Method 2-4): a common length of SBFD resource is configured for both of the first frame structure and the second frame structure. And the starting point or ending point of the SBFD resource in different frame structures can be different. For example, the starting point or ending point of the SBFD resource in different frame structures can be configured independently. Alternatively, the starting point or ending point of the SBFD resource in different frame structures can be defined by a reference point, for example, the reference point can be defined as one of, starting of the first DL slot or symbol within each pattern period, starting of the pattern period, starting of the first UL/flexible slot or symbol within the pattern period, or ending of the last DL slot or symbol within the pattern period.

For another method (Method 2-5): a common SBFD resource configuration is used for both of the first frame structure and the second frame structure. When the configured SBFD resource in one pattern period overlapping with a UL resource or overlapping with either a UL resource or a flexible resource, the overlapping part of SBFD resource is considered as an invalid SBFD resource, or don't define as an SBFD resource, or the whole SBFD resource within this pattern period will be dropped, i.e., there is no SBFD resource in this pattern period. The SBFD resource can be configured by using any method described in Embodiment Set I.

For a non-limiting example as shown in FIG. 6D, the SBFD resource is configured with the SBFD resource period being equal to at least one of the pattern period, i.e., 5 ms in this example. The index of the starting slot within the SBFD resource period is slot #1, and the starting symbol index within the starting slot is symbol #7. The index of the ending slot within the SBFD resource period is slot #2, and the ending symbol index within the ending slot is symbol #13. For the second frame pattern, the configured SBFD resource are overlapping with the UL resource and flexible resource, and the overlapping part is not considered as SBFD resource. Then, the SBFD resource in the second pattern period is ended as symbol #9 of slot #2 of the second pattern period; and the resource in dotted box is not defined as an SBFD resource. In some implementations, alternatively, the whole SBFD resource within the second pattern period may be dropped, i.e., there is no SBFD resource in the second pattern period.

In some implementations, the first pattern period and the second pattern period may be different. Then, the SBFD resource period equals to the larger or smaller period of the first pattern period and the second pattern period.

For another method (Method 2-6): One SBFD resource configuration is configured for both of the first pattern and the second pattern. When the configured SBFD resource overlapping with a UL resource or overlapping with either a UL resource or a flexible resource, the overlapping part of SBFD resource is considered as an invalid SBFD resource, or don't define as an SBFD resource. In some implementations, the configuration period for the SBFD resource equals to a sum of the first pattern period and the second pattern period.

For a non-limiting example as shown in FIG. 6E, the index of the starting slot within the SBFD resource period is slot #1, and the starting symbol index within the starting slot is symbol #7. The index of the ending slot within the SBFD resource period is slot #6, and the ending symbol index within the ending slot is symbol #6. Then, the configured SBFD resource are overlapping with the UL resource and flexible resource, and the overlapping part (dotted line) is not considered as SBFD resource. Then, the SBFD resource in the first pattern period is from symbol #7 of slot #1 to symbol #5 of slot #3. And the SBFD resource in the second pattern period is from symbol #0 of slot #5 to symbol #6 of slot #6.

The present disclosure describes various embodiments providing methods for configuring or defining time domain structure for the SBFD resource under two-pattern TDD frame structure, through which the SBFD resource can be determined and indicated efficiently.

### Embodiment Set III

The present disclosure describes various embodiments including methods for configuring or defining time domain structure for the SBFD resource by considering UE-specific TDD frame structure configuration.

In various embodiments, the TDD frame structure configuration may be divided into two steps, i.e., cell specific TDD frame structure configuration (e.g., by a signaling TDD-UL-DL-ConfigCommon), and UE specific TDD frame structure configuration (e.g., by a signaling TDD-UL-DL-ConfigDedicated). In some implementations, the UE specific TDD frame structure configuration may be only valid for the flexible resource configured by cell specific TDD frame structure configuration when provided. When the cell specific TDD frame structure is not provided, the UE specific TDD frame structure configuration is valid for all slots.

In some implementations, when SBFD resource is configured in the flexible resource (the flexible resource is configured by cell specific TDD frame structure configuration), the SBFD resource configured in the flexible resource may only be configured as DL resource by UE specific TDD frame structure.

In some implementations, when SBFD resource is configured in the flexible resource (the flexible resource is configured by cell specific TDD frame structure configuration), the SBFD resource configured in the flexible resource may only be configured as DL resource or flexible resource by UE specific TDD frame structure.

In some implementations, when SBFD resource is configured in the flexible resource (the flexible resource is configured by cell specific TDD frame structure configuration), the SBFD resource configured in the flexible resource may not be configured as UL resource by UE specific TDD frame structure.

In some implementations, when SBFD resource is configured in the flexible resource (the flexible resource is configured by cell specific TDD frame structure configuration), the SBFD resource configured in the flexible resource may be terminated by UL resource configured by UE specific TDD frame structure. For a non-limiting example as shown in FIG. 7, the SBFD resource may be terminated at symbol #9 of slot #3.

In some implementations, when SBFD resource is configured in the flexible resource (the flexible resource is configured by cell specific TDD frame structure configuration), the SBFD resource configured in the flexible resource may be terminated by flexible resource configured by UE specific TDD frame structure.

In some implementations, when SBFD resource is configured in the flexible resource (the flexible resource is configured by cell specific TDD frame structure configuration), the SBFD resource configured in the flexible resource may be divided into multiple segments by UL resource configured by UE specific TDD frame structure. For a non-limiting example as shown in FIG. 7, the SBFD resource may be divided into two segments by the UL resource in slot #3.

Various embodiments in the present disclosure provide methods for configuring or defining time domain structure for the SBFD resource by considering UE-specific TDD frame structure configuration, through which the SBFD resource can be determined and indicated efficiently.

### Embodiment Set IV

The present disclosure describes various embodiments including methods for configuring or defining time domain structure for the SBFD resource by considering cell-specific and/or UE-specific TDD frame structure configuration, wherein the SBFD resource may have a two-level configuration.

In various embodiments, the first level SBFD resource configuration may only be configured within DL resource configured by cell specific TDD frame structure configuration. When the configured first level SBFD resource is overlapping with flexible resource configured by cell specific TDD frame structure configuration, the overlapping part of SBFD resource may be defined as invalid SBFD resource, or not be defined as an SBFD resource. In some examples, the first level SBFD resource configuration is a cell specific SBFD resource configuration.

In various embodiments, the second level SBFD resource may be configured within the DL resource or within either DL resource or flexible resource configured by UE specific TDD frame structure configuration. In some examples, the second level SBFD resource configuration is a UE specific SBFD resource configuration.

In some implementations, the first level SBFD resource and the second level SBFD resource are continuous in the time domain.

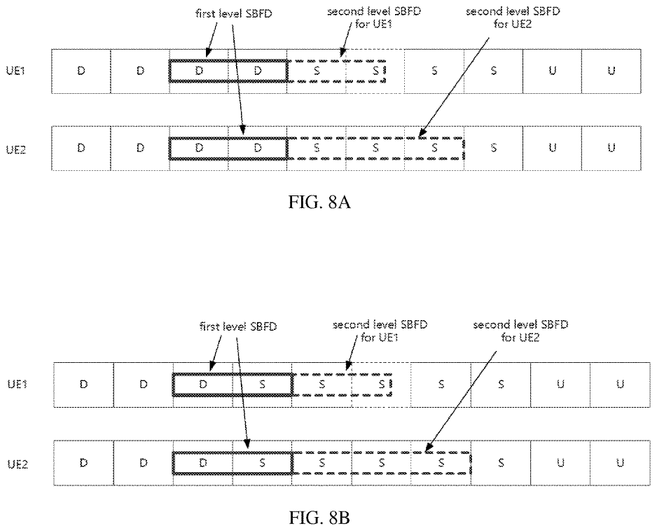

For one non-limiting example as shown in FIG. 8A, the first level SBFD resource is same for different UEs (UE1 and UE2), and the second level SBFD resource is different for different UEs.

In some implementations, the first level SBFD resource configuration can be configured within DL resource or flexible resource configured by cell specific TDD frame structure configuration. In some examples, the first level SBFD resource configuration is a cell specific SBFD resource configuration. The second level SBFD resource is configured within the DL resource or within either DL resource or flexible resource configured by UE specific TDD frame structure configuration. In some examples, the second level SBFD resource configuration is a UE specific SBFD resource configuration. In some implementations, the first level SBFD resource and the second level SBFD resource are continuous in the time domain. For another non-limiting example as shown in FIG. 8B, the first level SBFD resource is same for different UEs (UE1 and UE2), and the second level SBFD resource is different for different UEs.

Various embodiments in the present disclosure provide methods for configuring or defining time domain structure for the SBFD resource by considering cell-specific and/or UE-specific TDD frame structure configuration, through which the SBFD resource can be determined and indicated efficiently.

In some implementations, in addition to subband full-duplex (SBFD), full-duplex may also be defined as in-band full-duplex (Inband Full Duplex, IBFD), and IBFD resource configuration may include the following operations:

In a carrier, the base station configures a set of continuous resource blocks (RBs) for an IBFD operation in the frequency domain, and configures some slots or symbols for an IBFD operation in the time domain based on a symbol or a slot. In this way, some time-frequency resources used for an IBFD operation may be obtained. The time-frequency resource is also referred to as an IBFD subband, and can be used for both of downlink transmission and uplink reception. At least on a base station side, the IBFD subband can be used for transmitting the downlink signal and receiving the uplink signal in the IBFD sub-band at a same time and a same frequency. The UE side may support only DL transmission and UL transmission in a time division manner.

A symbol/slot on which an IBFD subband is configured is referred to as an IBFD symbol/slot, and a symbol/slot on which no IBFD subband is configured is referred to as a non-IBFD symbol/slot (for example, a conventional DL, UL, or flexible symbol/slot). The methods for configuring a time domain resource of an FD resource described in the present invention is also applicable to configuring an IBFD symbol/slot.

The present disclosure describes methods, apparatus, and computer-readable medium for wireless communication. The present disclosure addressed the issues with FD and/or SBFD. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art may recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a user equipment (UE), configuration information from a base station for configuring full duplex (FD) resource in a time domain; and
determining, by the UE, the FD resource in the time domain based on the configuration information.

2-8. (canceled)

9. The method according to claim 1, wherein:
the FD resource comprises a first FD resource and a second FD resource;
the frame structure period comprises a first frame structure period and a second frame structure period; and
the first FD resource and the second FD resource are independently configured in the first frame structure period and the second frame structure period, respectively.

10. The method according to claim 9, wherein:
a period for the first FD resource is same as a period of the second FD resource, and equals to a sum of the first frame structure period and the second frame structure period.

11-21. (canceled)

22. The method according to claim 1, wherein:
the FD resource in the time domain comprises consecutive symbols.

23. The method according to claim 22, wherein:
the FD resource in the time domain is configured via at least one of the following parameters: a starting slot index, a starting symbol index, an ending slot index, an ending symbol index.

24. A method for wireless communication, comprising:
determining, by a base station, full duplex (FD) resource in a time domain; and
sending, by the base station, configuration information to a user equipment (UE) for configuring the FD resource in the time domain.

25. The method according to claim 24, wherein:
the FD resource comprises a first FD resource and a second FD resource;
the frame structure period comprises a first frame structure period and a second frame structure period; and
the first FD resource and the second FD resource are independently configured in the first frame structure period and the second frame structure period, respectively.

26. The method according to claim 25, wherein:
a period for the first FD resource is same as a period of the second FD resource, and equals to a sum of the first frame structure period and the second frame structure period.

27. The method according to claim 24, wherein:
the FD resource in the time domain comprises consecutive symbols.

28. The method according to claim 27, wherein:
the FD resource in the time domain is configured via at least one of the following parameters: a starting slot index, a starting symbol index, an ending slot index, an ending symbol index.

29. A user equipment (UE) comprising:
a memory storing instructions; and
at least one processor in communication with the memory, wherein, when the at least one processor executes the instructions, the at least one processor is configured to cause the UE to:
receive configuration information from a base station for configuring full duplex (FD) resource in a time domain; and
determine the FD resource in the time domain based on the configuration information.

30. The UE according to claim 29, wherein:
the FD resource comprises a first FD resource and a second FD resource;
the frame structure period comprises a first frame structure period and a second frame structure period; and
the first FD resource and the second FD resource are independently configured in the first frame structure period and the second frame structure period, respectively.

31. The UE according to claim 30, wherein:
a period for the first FD resource is same as a period of the second FD resource, and equals to a sum of the first frame structure period and the second frame structure period.

32. The UE according to claim 29, wherein:
the FD resource in the time domain comprises consecutive symbols.

33. The UE according to claim 32, wherein:
the FD resource in the time domain is configured via at least one of the following parameters: a starting slot index, a starting symbol index, an ending slot index, an ending symbol index.

34. A base station comprising:
a memory storing instructions; and
at least one processor in communication with the memory, wherein, when the at least one processor executes the instructions, the at least one processor is configured to cause the base station to:
determine full duplex (FD) resource in a time domain; and
send configuration information to a user equipment (UE) for configuring the FD resource in the time domain.

35. The base station according to claim 34, wherein:
the FD resource comprises a first FD resource and a second FD resource;
the frame structure period comprises a first frame structure period and a second frame structure period; and
the first FD resource and the second FD resource are independently configured in the first frame structure period and the second frame structure period, respectively.

36. The base station according to claim 35, wherein:
a period for the first FD resource is same as a period of the second FD resource, and equals to a sum of the first frame structure period and the second frame structure period.

37. The base station according to claim 34, wherein:
the FD resource in the time domain comprises consecutive symbols.

38. The base station according to claim 37, wherein:
the FD resource in the time domain is configured via at least one of the following parameters: a starting slot index, a starting symbol index, an ending slot index, an ending symbol index.
